(19) United States
(12) Patent Application Publication
(10) Pub. No.: US 2009/0151092 A1
(43) Pub. Date: Jun. 18, 2009

(54) Unique Tread Marked Apparel

(76) Inventor: Robin Bender Bender, Wausaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/371,870

(22) Filed: Feb. 16, 2009

Related U.S. Application Data
(63) Continuation-in-part of application No. 11/870,283, filed on Oct. 10, 2007.

(51) Int. Cl. D06P 5/24; B41F 16/02; B05C 1/08

(52) U.S. Cl. 8/487; 118/258

(57) ABSTRACT

A method and apparatus for printing a forensically unique demarcation on a fabric substrate and mass producing fabric articles which displaying varying gradients in color reflecting the variations in pressure and motion of a tire wherein a unique tire tread mark capable being distinguished by forensic analysis is created.

### CLAIM OF PRIORITY

This application is a claims priority to U.S. patent application Ser. No. 11/870,283 filed Oct. 10, 2007.

### FIELD OF INVENTION

This invention relates generally to the field of printing on fabric substrates, and in particular to using tire tread marks and devices which emulate unique tire tread marks unique, forensically identifiable articles.

### BACKGROUND

Designer clothing accessories generated more than $200 billion in the US in 2008. The desire for unique and distinctive clothing is a particular driving force.

In recent years the fashion industry has embraced the look of distressed, faded, and tattered looking clothing to add distinctiveness and status. Other stylistic trends include “faded,” “stonewashed,” “acid washed,” “enzyme washed,” and “crushed” jeans as popular clothing items. In order to create the distressed clothing, jean manufacturers have in the past employed various combinations of physical and chemical processes, including sanding with sandpaper, washing with pieces of pumice stone, and using bleaching agents and enzymes to “bio-polish” and create a distinctive “stonewashed” look.

There is a consistent demand in the market for distinctive, one-of-a-kind items of clothing, and for stylized blue jeans. Most consumers cannot afford to purchase unique items of clothing, and purchase items which are mass produced.

In addition to the foregoing clothing trends, many consumers have an affinity for certain type of vehicle (e.g. a Harley-Davidson™ motorcycle or a particular make and model of a sports car). Each type of vehicle makes distinctive road tread marks. It is desirable to capitalize on a market which combines consumers' affinity for distinctive fashion which the consumer market for automobile-related accessories.

It is desirable to have a method of manufacture for creating items of clothing which are unique, forensically distinguishable, and technically one-of-a kind the look of distinctive tire tread patterns, such that each tread pattern created on an item of clothing is one-of-a-kind and unique.

Tire tread patterns are distinctive patterns, often used for forensic analysis to determine many characteristics of a vehicle, road conditions and travel patterns.

Glossary

As used herein, the term “tire tread” means a distinctive pattern created as the tire rolls, and various patterned surfaces make contact with the road way or objects on the road way. A tire tread is a distinctive pattern which may be used for forensic analysis, the exact characteristics of which depend on the manufacturer's tread pattern, inflation pressure, road surface characteristics, rotating speed, and numerous physical properties of the tire structure, such as spring force and stiffness.

As used herein, the term “rotary device” means any machine or apparatus, whether mechanized or hand-held, to which a round structure can be rotatably mounted and rolled over an item of fabric or clothing to create a tire tread mark.

As used herein, the term “tread screen” means a screen device having a pattern to create light, dark, and irregularly shaped areas which can be placed or manipulated to create unique or quasi-unique tire tread marking patterns, including but not limited to emulating varying pressures over the surface of the tread pattern.

As used herein, the term “vehicle” means a car, a motorcycle or any other equipment to which a tire or portion of a tire may be mounted.

As used herein, the term “textured device” means a pad, sprayer, sponge, paint brush or other device used for creating a texture or textured effect.

As used herein, the term “grasping arm” means any rod, lever arm or handle to which a tire, partial tire, device simulating a tire or textured device may be mounted.

### BRIEF DESCRIPTION OF THE DRAWINGS

FIG. 1 is a front view of one exemplary of a pair of jeans having simulated tire tracks.

FIG. 2 is a front view of an exemplary rotary devices used to create similar tire tracks.

### SUMMARY OF THE INVENTION

The invention disclosed herein is a method and apparatus for printing a forensically unique demarcation on a fabric substrate and mass producing fabric articles which displaying varying gradients in color reflecting the variations in pressure and motion of a tire wherein a unique tire tread mark capable being distinguished by forensic analysis is created. A method is disclosed wherein a fabric substrate is stretched for form a substantially taut (secured) surface, and at least one tire, tire component or tire simulating apparatus (such as a tread screen is used to create at least one tire tread marking displaying varying gradients in color reflecting the variations in pressure and motion of a tire.

### DETAILED DESCRIPTION OF EMBODIMENTS OF THE INVENTION

For the purpose of promoting an understanding of the present invention, references are made in the text hereof to embodiments of fabric articles having simulated tire tracks and a method of making same, only some of which are depicted in the figures. It should nevertheless be understood that no limitations on the scope of the invention are thereby intended. One of ordinary skill in the art will readily appreciate that modifications such as the dimensions, size, and shape of the fabric article, alternate materials from which the fabric article is made, and the inclusion of additional aesthetic elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

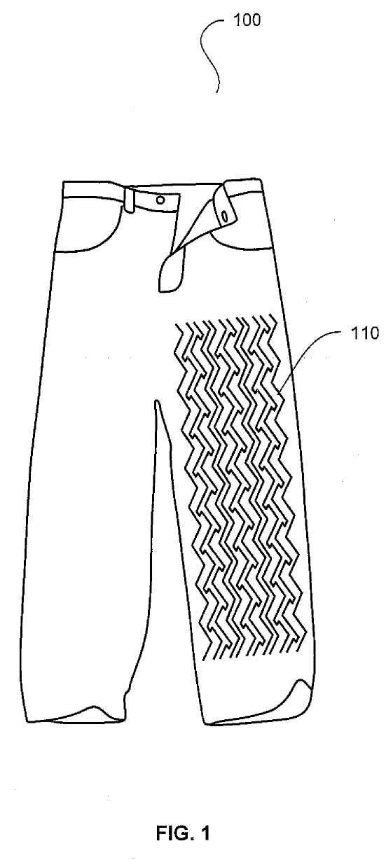

Referring now to the drawings, FIG. 1 is a front view of one exemplary embodiment of fabric article 100 made by the method disclosed herein, having unique tire tread or simulated tire treads 110 disposed thereon. In the embodiment shown, fabric article 100, in the embodiment shown, is a unique pair of designer jeans which has been mass-produced by the method disclosed herein, but could alternately be any other garment or fabric surface. In the embodiment shown, fabric article 100 includes tread mark 110 which is a unique or quasi-unique pattern reflecting a distinctive pattern (e.g., of a type which may be used for forensic analysis) having or emulating characteristics of a tread pattern, reflecting the structural configuration and wear of a tire, inflation pressure, road surface characteristics, rotating speed, and numerous physical properties of the tire structure, such as spring force and stiffness.

In the embodiment shown, a tread mark is created using a vehicle as a rotary device. In various embodiments, the rotary device may be a machine to which an actual tire or tire replica is mounted, a rubber or plastic component which stamps a tire tread, a pad or stamping device, a manually operated unit to which a tire or tire replica is mounted or a tread screen device having a pattern to create light, dark, and irregularly shaped areas which can be placed or manipulated to create unique or quasi-unique tire tread marking patterns, including but not limited to emulating varying pressures over the surface of the tread pattern. In still other embodiments, the rotary device used may be a motorcycle, an imprint of an actual car, a roller-skate type device, a tractor or a device that is manipulated in the manner of a baby stroller.

Tread mark 110 may be on the front of fabric article 100 (as shown), on the back of fabric article 100, or both. Tread marks 110 can be in any direction, including starting on the front and continuing on the back of fabric article 100. Moreover, multiple tread marks 110 can be included on fabric article 100 to create an even more unique or distinctive fabric article 100.

In the embodiment shown, tread marks 110 are from a generic tire. However, tread marks 110 may reflect a specific make and model of vehicle and/or movement pattern For example, for some companies related to vehicles, tire tracks 110 can simulate a John Deere® tractor, a Firestone® tire, or a Harley-Davidson® motorcycle tire. Furthermore, tire tracks 110 can be added to fabric article 100 that has a company logo 115 on it. For example, a generic or specific motorcycle tire track can be included on a Harley-Davidson® t-shirt, a tractor tire track can be included on a t-shirt having a John Deere® logo or a Caterpillar® logo on it, or any other distinctive tread pattern related to the company whose logo 115 is on the t-shirt [020] It should be understood that fabric article 100 with simulated tire tread 100 in accordance with the present invention can be made in several ways. For example, the fabric article or fabric from which the fabric article is to be made can be actually driven over by a vehicle that has paint or another material disposed on its tires. In addition, the tire tracks can be simulated and imparted on to the fabric article by screen printing. The screen printing can be imparted directly on the fabric article or can be imparted on to the fabric and the fabric used to make the fabric article. Moreover, the simulated tire track can be actual size or can be larger or smaller, depending on the particular fabric article.

While the fabric articles with simulated tire tracks have been shown and described with respect to several embodiments and materials in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

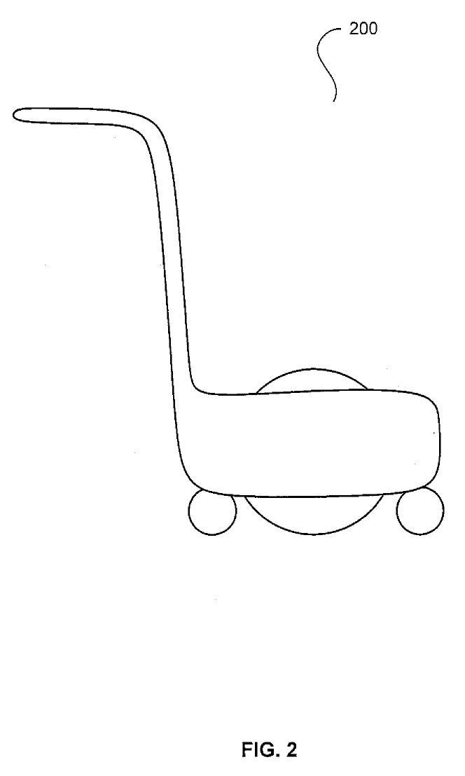

FIG. 2 illustrates an exemplary rotary device 200, which is a tire mounted to an axle, and hand driven by steering component 210 over an fabric article to create a distinctive tread pattern. In various embodiments, rotary device 200 may be mechanized, or a component of a larger device.

What is claimed is:

1. A method of imprinting a unique pattern on a fabric substrate comprising the steps of:
Stretching the fabric substrate to form a substantially taut surface;
Placing at least one tire component in contract with said substrate to create at least One tire tread marking displaying varying gradients in color reflecting the variations in pressure and motion of a tire.

2. The fabric substrate of claim 1, wherein said tread marking capable of being distinguished by forensic analysis.

3. The method of claim 1, wherein said tire component is mounted to a vehicle.

4. The method of claim 1, wherein said tire component is mounted to a manual rotary device.

5. The method of claim 1, wherein said tire component consists of a manual rotary device to which a portion tire has been mounted.

6. The method of claim 1, wherein said tire component is a manual rotary device to which a simulated tire has been mounted.

7. The method of claim 1, wherein said tire component is a tire is a tread screen.

8. The method of claim 1, wherein a clothing accessory is created using tread screens.

9. The method of claim 1 wherein said tire component is a textured device capable of being manipulated to simulate tread mark pressure differentials created by a tread screen.

10. A method of manufacturing a forensically unique fabric article consisting of manufacture comprised of:
Securing at least one fabric article having at least one surface; and
Placing at least one tire tread marking displaying varying gradients in color reflecting the variations in pressure and motion of a tire tread on said fabric article.

11. The method of claim 10 wherein said tire tread is and capable of being distinguished by forensic analysis.

12. The method of claim 10, wherein said tread mark is created using a vehicle.

13. The method of claim 10, wherein said tread mark is created using a manual rotary device to which a tire has been mounted.

14. The method of claim 10, wherein said tread mark is created using a manual rotary device to which a portion of a tire has been mounted.

15. The method claim 10, wherein said tread mark is created using at least one tread screen.

16. The method claim 10, wherein said tread mark is created using a textured device capable of being manipulated to simulate tread mark pressure differentials created by a tread screen.

17. An apparatus for producing a forensically unique article of clothing in quantity comprised of:
at least one tire component;
at least one movable mounting surface to which said tire component has been secured which may be used to place said tire component in contract with said article of clothing. component for securing a fabric article of manufacture created by a device to which a tire has been rotatably mounted.

18. The apparatus of claim 17, wherein said at least one movable mounting surface further includes a component which rotates about an axis.

19. The apparatus of claim 17 wherein said movable mounting service is a motor vehicle.

20. The apparatus of claim 17, wherein said movable mounting surface is selected from a group consisting of at least one rotary device, at least one tread screen, at least one mounted portion of a tire fixable mounted to a grasping arm and at least one textured device.
